(19) United States
(12) Patent Application Publication
(10) Pub. No.: US 2017/0163312 A1
(43) Pub. Date: Jun. 8, 2017

(54) ELECTRONIC SYSTEM WITH NETWORK OPERATION MECHANISM AND METHOD OF OPERATION THEREOF

(71) Applicant: Samsung Electronics Co., Ltd., Suwon-si (KR)

(72) Inventors: Zhan Ping, San Jose, CA (US); Yang Seok Ki, Palo Alto, CA (US)

(21) Appl. No.: 15/139,298

(22) Filed: Apr. 26, 2016

Related U.S. Application Data
(60) Provisional application No. 62/262,517, filed on Dec. 3, 2015.

(51) Int. Cl. H04B 5/00; H04L 12/24

(52) U.S. Cl. CPC H04B 5/0031; H04L 41/0853

(57) ABSTRACT

An electronic system includes: a storage device configured to receive a host command including: a system interface unit, a device controller, coupled to the system interface unit, configured to analyze the host command, a near-field wireless transceiver, coupled to the device controller, configured to communicate through a wireless link, and a non-volatile storage array, coupled to the device controller, configured to store user data for transfer through the system interface unit or the near-field wireless transceiver; wherein: the device controller can configure the near-field wireless transceiver for identifying a multi-hop map; and the near-field wireless transceiver is configured to hand-off the host command through the wireless link.

### CROSS REFERENCE TO RELATED APPLICATION(S)

This application claims the benefit of U.S. Provisional Patent Application Ser. No. 62/262,517 filed Dec. 3, 2015, and the subject matter thereof is incorporated by reference herein.

### TECHNICAL FIELD

An embodiment of the present invention relates generally to an electronic system, and more particularly to a system for data storage functions of electronic systems.

### BACKGROUND

Modern solid state disks (SSDs) represent a growing segment of the data storage strategies market due to their speedy response during data operations. Large numbers of these SSDs can provide data centers with higher capacity, lower power consumption, and higher performance than magnetic disk drives. As the migration to SSDs gains momentum, a question arises as to how to best utilize their capacity and performance. System operating systems in current server architectures require that data exchanges among storage devices involve a server processor that accounts for the location and integrity of the data. This requires the processor/controller to move data explicitly from one drive to another drive. Even when the data size is small, the data must traverse the same, extended data path through the system interface and the controller memory.

The logistics of manipulating large databases exposes weakness in the technology of the operating systems. Drive-to-drive intercommunication and data exchanges commonly occur. Efficient inter-drive data exchange is directly related to system power efficiency, TCO, and performance. Since any data exchange must traverse the system interface, data congestion can limit the overall performance of larger storage arrays.

Thus, a need still remains for electronic system with network operation mechanisms to improve execution reliability and performance in data center computing environments. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides an electronic system including: a storage device configured to receive a host command including: a system interface unit, a device controller, coupled to the system interface unit, configured to analyze the host command, a near-field wireless transceiver, coupled to the device controller, configured to communicate through a wireless link, and a non-volatile storage array, coupled to the device controller, configured to store user data for transfer through the system interface unit or the near-field wireless transceiver; wherein: the device controller can configure the near-field wireless transceiver for identifying a multi-hop map; and the near-field wireless transceiver is configured to hand-off the host command through the wireless link.

An embodiment of the present invention provides a method of operation of an electronic system including: receiving a host command by a storage device including: transferring the host command by a system interface unit, analyzing the host command by a device controller, communicating through a wireless link via a near-field wireless transceiver configured by the device controller, and transferring user data through the system interface unit or the near-field wireless transceiver; identifying a multi-hop map by the device controller for the near-field wireless transceiver; and handing-off the host command through the wireless link.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an architectural block diagram of an electronic system with network operation mechanism in an embodiment.

FIG. 2 is an architectural block diagram of a storage device of the electronic system in an embodiment.

FIG. 3 is an architectural block diagram of a storage array of the electronic system in an embodiment.

FIG. 4 is a flow chart of a method of operation of an electronic system in a further embodiment of the present invention.

### DETAILED DESCRIPTION

Various embodiments provide a network operation mechanism for large databases that can simplify the distributed input/output (I/O) interface and maximize the execution efficiency of the electronic system by establishing a less burdensome I/O architecture. The network operation mechanism can be configured to process the data used in a user program without adding to the congestion of the system interface. The execution of the network operation mechanism can be configured to provide efficient access to storage devices and provide the maximum program execution efficiency by reducing the congestion on the system interface.

Various embodiments provide a network operation mechanism for large databases by allowing large transfers outside the customary I/O storage stacks provided by operating system architectures. The electronic system can also support the fixed block architecture prevalent in today's operating systems. This combination can increase the efficiency and operational performance of the electronic system.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

The term “module” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof. Further, if a module is written in the apparatus claims section below, the modules are deemed to include hardware circuitry for the purposes and the scope of apparatus claims.

The term “unit” referred to herein is a circuit formed of hardware components or hardware state machines used for specific functions. The “unit” can be for timing critical functions and does not necessarily include software functions or support.

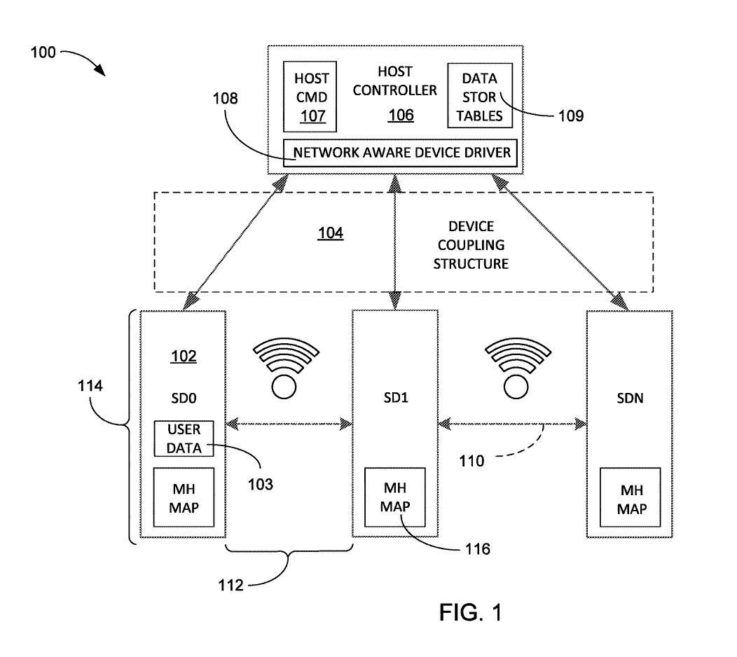

Referring now to FIG. 1, therein is shown an architectural block diagram of an electronic system 100 with network operation mechanism in an embodiment. The electronic system 100 includes storage devices 102, examples of such devices can include solid state storage devices (SSSD) based on Flash memory, magnetic random access memory (MRAM), Resistive Random Access Memory (RRAM), and Phase Change Memory (PCM), as well as hybrid disk storage devices. The storage devices 102 can be a non-volatile data storage mechanism that can store and retrieve user data 103. The storage devices 102 can be used for storage and retrieval of the user data 103 for processing in a computing environment, for managing databases, as well as transfers from the operating system.

A device coupling structure 104 can link the storage devices 102 to a host controller 106. The device coupling structure 104 can be an input/output interface structure connected between the host controller 106 and the storage devices 102. The device coupling structure 104 can include a peripheral computer interface express (PCI-e), fiber channel (FC), small computer system interface (SCSI), serial attached SCSI (SAS), serial advanced technology attachment (SATA), Ethernet, and the host's memory channel interface. The device coupling structure 104 can be implemented as a memory bus for host internal applications of the electronic system 100. The device coupling structure 104 can provide local or remote connectivity between the host controller 106 and the storage devices 102. The connection of the device coupling structure 104 between the storage devices 102 and the host controller 106 is performed in a manner that meets the specification of the device coupling structure 104.

The device coupling structure 104 can provide direct coupling and communication to the storage devices 102 for transferring a host command 107 and the user data 103. The host controller 106 can be a general purpose computer, a computer network, a server, a storage processor, GPU, ASIC, FPGA, PLD, or the like. The host controller 106 can execute a network aware device driver 108 for communicating with and taking advantage of the storage devices 102.

The network aware device driver 108 provides an application interface that allows user applications to access the storage devices 102 without including a description of the operational characteristics of the storage devices 102. The network aware device driver 108 is a program that translates standard application instructions into a form that is recognized by the storage devices 102 in order to enable additional functionality. The network aware device driver 108 translates the application requirements into the host command 107 that are recognized by the storage devices 102. The host command 107 can include conditioning commands and data processing commands. The network aware device driver 108 can update data storage tables 109 within the host processor 106 in order to maintain the correct location of the user data 103 stored in the storage devices 102.

The storage devices 102 can communicate among themselves through a wireless link 110. The wireless link 110 can provide a communication path for a load balancing function between the storage devices 102. The wireless link 110 can be a near-field wireless communication structure that can provide any of the storage devices 102 within a communication range 112 the ability to join a storage network 114. The storage network 114 can be a multi-hop ad hoc wireless network that is formed by peer-to-peer communication between the storage devices 102 within the communication range 112 of the wireless link 110.

It is understood that the default configuration of the storage devices 102 can allow them to seek any additional ones of the storage devices 102 within the communication range 112 for forming the storage network 114 through the wireless link 110. The formation of the storage network 114 can occur at power-on, during interface resets, or as a result of the host command 107 from the network aware device driver 108. In an embodiment where the storage network 114 is already established, replacing one of the storage devices 102 can cause the reforming of the storage network 114 as commanded by the network aware device driver 108. Each of the storage devices 102 can initiate a mapping of the adjacent ones of the storage devices 102 that can form the storage network 114. Each member of the storage network 114 can maintain a multi-hop map 116 that shows all of the storage devices 102 included in the storage network 114, their individual status, and availability to accept a hand-off of the host command 107 through the wireless link 110. The storage devices 102 can monitor the multi-hop map 116 and maintain a current status of availability of the other storage devices 102 in the storage network 114.

The storage network 114 can be utilized by the storage devices 102 to share status and workload across the storage network 114. In combination with the network aware device driver 108, the storage devices 102 can pass a storage task to a less busy one of the storage devices 102. When the host controller uses the network aware device driver 108 to send a file for storage to a specific one of the storage devices 102, a different one of the storage devices can request the user data 103 for storage and the network aware device driver 108 can update the file system with the change in storage devices 102. In the case of small data transfers moved between storage devices 102 in the storage network 114, the user data 103 can be transferred across the wireless link 110 and the terminal status for the host command 107 can be provided by the destination one of the storage devices 102.

It has been discovered that the electronic system 100 can enhance performance of the host controller 106 by allowing small transfers of the user data 103 between two of the storage devices 102 to take place through the storage network 114. The network aware device driver 108 can acknowledge that the small transfers of the user data 103 from the host command 107 sent to one of the storage devices 102 can have terminal status provided by a different one of the storage devices 102 designated as the destination device in the host command 107. The storage devices 102 can utilize the multi-hop map 116 in order to identify a path to the one of the storage devices 102 designated to be the destination device. The network aware device driver 108 can update the data storage tables 109 to reflect the completion of the transfer of the user data 103 as reflected by the terminal status from the host command 107.

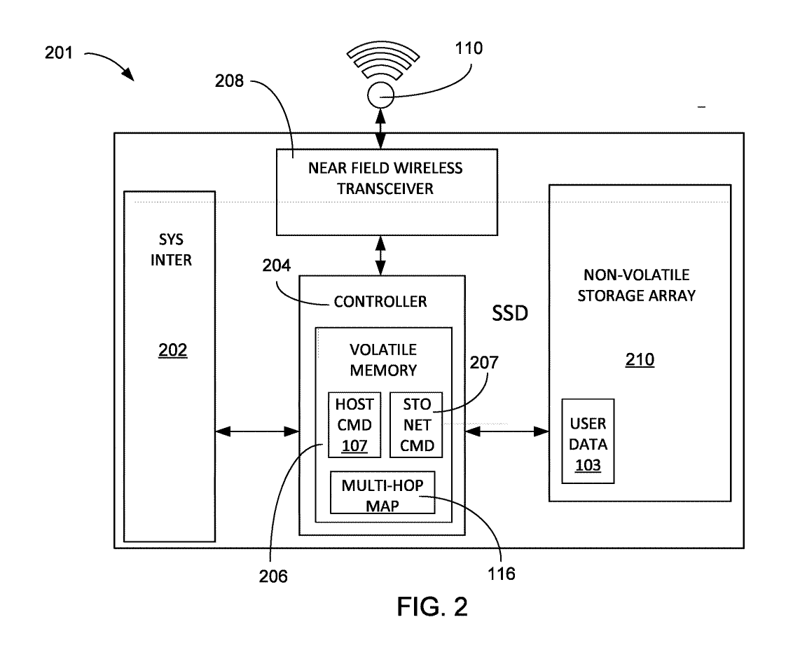

Referring now to FIG. 2, therein is shown an architectural block diagram of a storage device 201 of the electronic system 100 in an embodiment. The architectural block diagram of a solid-state storage device 201 depicts a system interface unit 202 that can communicate through the device coupling structure 104 of FIG. 1 coupled to a device controller 204. The device controller 204 can control the operations of the solid-state storage device 201. The device controller 204 can be an embedded processor, a micro-processor, a micro-computer, a sequential state machine, a logic sequencer, or the like.

The device controller 204 can include a volatile memory 206 for accessing the device firmware, transient interface data, the host command 107, storage network commands 207, and the multi-hop map 116. The device controller 204 can be coupled to a near-field wireless transceiver 208 and a non-volatile storage array 210. The near-field wireless transceiver 208 can be based on RFID, BlueTooth® Low Energy, Nearby®, WiFi, cellular, or the like. The non-volatile storage array 210 can be based on flash memory, magnetic random access memory (MRAM), Resistive Random Access Memory (RRAM), and Phase Change Memory (PCM), as well as magnetic disk storage devices.

The storage network commands 207 can be utilized to transfer user data through the near-field wireless transceiver 208 to a destination one of the solid-state storage device 201 either indicated by the host command 107 or identified by the device controller 204 as being available to execute the host command 107. The transfer of the host command 107 can be accommodated by the network aware device driver 108. The device controller 204 can access another of the solid-state storage device 201 via the wireless link 110 of FIG. 1 in order to hand-off the host command 107. In an embodiment, the network aware device driver 108 can issue the host command 107 to one of the solid-state storage device 201 indicating a data transfer through the wireless link 110 to another of the solid-state storage device 201 for storage.

The device controller 204 can configure the near-field wireless transceiver 210 to identify any of the storage devices 102 of FIG. 1 that are within the communication range 112 of the wireless link 110. Since each of the storage devices 102 can assemble their own version of the multi-hop map 116 an aggregated version of the multi-hop map 116 can be assembled by the device controller 204 to reflect the entirety of the storage network 114.

The device controller 204 can support the system interface unit 202 for executing the host command 107 received from the host processor 106 of FIG. 1. The device controller 204 can also maintain a status of the workload of the storage devices 102 associated with the storage network 114. In the event one of the storage devices 102 gets backlogged by the host command 107 from the host processor 106, the device controller 204 can generate the storage network command 207 for transferring the host command 107, to another of the storage devices 102 in the storage network 114, through the wireless link 110. The hand-off of the host command 107 from the host processor 106 can be accommodated by the network aware device driver 108 of FIG. 1 when the alternative one of the storage devices 102 requests the user data 103 to be transferred from the host processor 106. The network aware device driver 108 can update the data storage tables 109 of FIG. 1 to reflect the hand-off of the host command 107 and the final destination of the user data 103. The hand-off of the host command 107 can include transferring command content, the user data 103, or a combination thereof through the wireless link 110 to the alternative one of the storage devices 102 for execution and storage.

It has been discovered that an embodiment of the solid-state storage device 201 can reduce the congestion on the device coupling structure 104 by configuring and utilizing the storage network 114 to balance the workload among the storage devices. The network aware device driver 108 can anticipate a hand-off of the host command 107 to a different one of the storage devices 102 and update the data storage tables 109 of FIG. 1 within the host processor 106. The solid-state storage device 201 can operate singly as a normal non-networked solid state storage device without the support of the network aware device driver 108. The additional support of the near-field wireless transceiver 208 can increase the system performance and reduce congestion on the device coupling structure 104 by optimizing the device selection based on real-time workload of the storage devices 102 and removing the host command 107 and the small transfers of the user data 103 between the storage devices 102 from the device coupling structure 104.

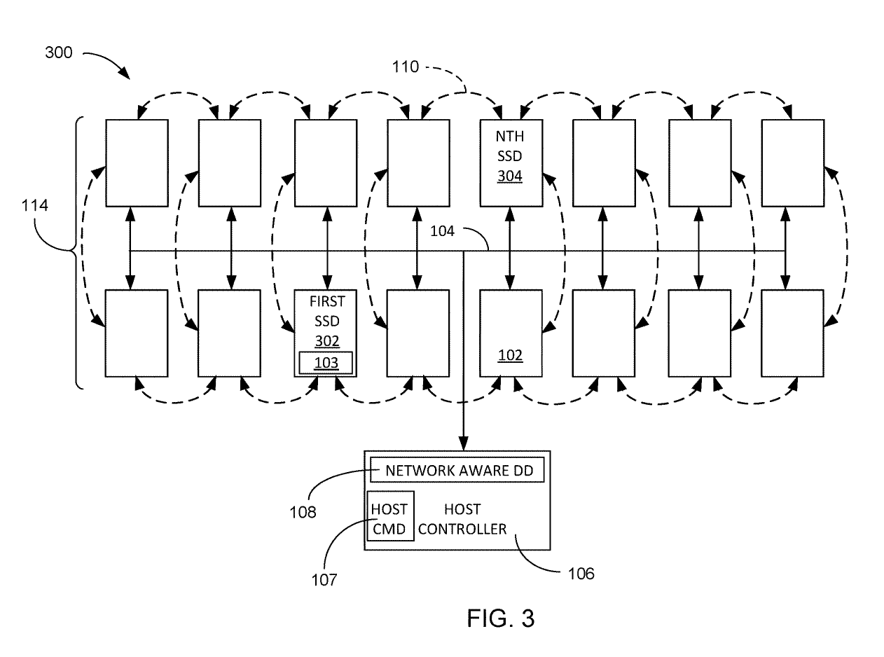

Referring now to FIG. 3, therein is shown an architectural block diagram of a storage array 300 of the electronic system 100 in an embodiment. The architectural block diagram of a storage array 300 depicts the host processor 106, having the network aware device driver 108, coupled to the storage array 114 through the device coupling structure 104. The wireless link 110 can couple each of the storage devices 102 of FIG. 1 within the communication range 112 of FIG. 1. It is understood the storage array 114 is an example only and a different number of the storage devices can be implemented. It is further understood that the physical configuration of the storage array 114 can result in a different configuration of the wireless link 110.

By way of an example, the host processor 106 can issue the host command 107 for a small data transfers to move the user data 103 from a first solid-state storage device 302 to an N^{th} solid-state storage device 304. In the operation of prior art systems, the first solid-state storage device 302 would have to transfer the user data 103 through the device coupling structure 104 to the host processor 106 and then the host processor 106 would send a subsequent one of the host command 107 to the N^{th} solid-state storage device 304 followed by the transfer of the user data 103 itself.

In an embodiment of the electronic system 100, the network aware device driver 108 can send a single one of the host command 107, for the small data transfer, to the first solid-state storage device 302, including the identification of the user data 103 and the destination device identified as the N^{th} solid-state storage device 304. The first solid-state storage device 302 can retrieve the user data 103 from the non-volatile storage array 210 of FIG. 2 and transfer the user data 103 by way of the near-field wireless transceiver 208 of FIG. 2 to the N^{th} solid-state storage device 304. Since the small data transfer is executed through the wireless link 110 based on a path identified from the multi-hop map 116 of FIG. 1, the terminal status for the small data transfer can be provided by the N^{th} solid-state storage device 304 to the network aware device driver 108. The network aware device driver 108 can update the data storage tables 109 of FIG. 1 to indicate the location of the user data 103.

The network aware device driver 108 can update the status for the small data transfer within the host processor 106 as though multiple of the host command 107 were executed across the device coupling structure 104, but without the overhead of additional command and transfers of the user data 103 moving through the device coupling structure 104. The reduction in congestion of the device coupling structure 104, the system memory within the host processor 106, and the reduced number of transfers across the system interface unit 202 of FIG. 2 can reduce the overhead and improve performance of the electronic system 100.

Further, if the host processor 106 transfers the host command 107 to the N^{th} solid-state storage device 304 while it is busy executing previous of the host commands 107, the N^{th} solid-state storage device 304 can hand-off the execution of the host commands 107 to the first solid-state storage device 302 through the wireless link 110. Since the first solid-state storage device 302 is not busy, it can immediately request the transfer of the user data 103 to execute the host commands 107. The network aware device driver 108 can recognize that the host command 107 has been handed-off to the first solid-state storage device 302 for quicker execution. The network aware device driver 108 can update the data storage tables 109 of the host processor 106 to reflect the updated destination as the first solid-state storage device 302 and transfer the user data 103 for the host command 107. When the first solid-state storage device 302 presents the terminal status for the host command 107, the network aware device driver 108 can store status normally to complete the host command 107.

It has been discovered that the electronic system 100 can improve the performance of the host processor over prior art systems by reducing congestion on the device coupling structure 104 and handing-off the host commands 107 to the first solid-state storage device 302 that is less busy. By handing-off the host command 107 and performing the small transfers of the user data 103 through the wireless link 110, the electronic system 100 can increase performance of the host processor 106 and reduce latency in the execution of host commands 107 issued to the storage network 114.

It is understood that the number and coupling of the storage devices 102 is an example of an embodiment of the electronic system 100. Any number of the storage devices 102 can be included in the storage array 114 with the wireless link 110 coupling any of the storage devices 102 within the communication range 112 of FIG. 1. The multi-hop map 116 of FIG. 1 can reflect the number and linkages of the storage devices 102 in the storage network 114. By way of an example the wireless link 110 is shown as having three hops between the first solid-state storage device 302 and the N^{th} solid-state storage device 304, but any number of hops is possible. It is understood that additional hops of the wireless link 110 can increase the latency of the transfer through the storage network 114.

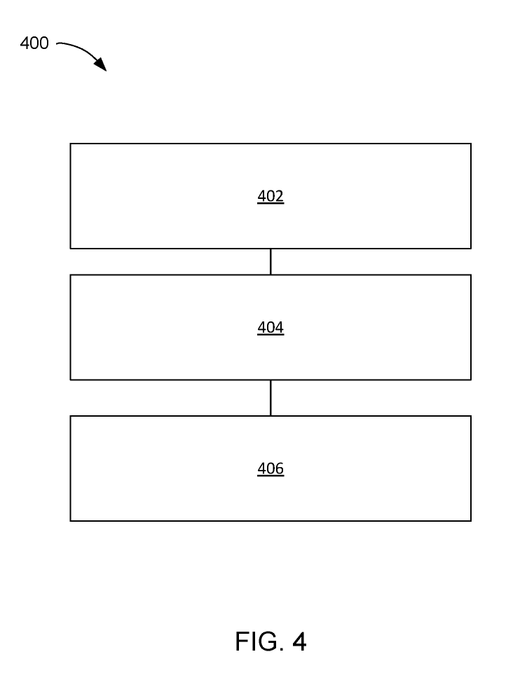

Referring now to FIG. 4, therein is shown a flow chart of a method 400 of operation of an electronic system 100 in a further embodiment of the present invention. The method 400 includes: receiving a host command 107 by a storage device 102 including: transferring the host command 107 by a system interface unit 202, analyzing the host command 107 by a device controller 204, communicating through a wireless link 110 via a near-field wireless transceiver 208 configured by the device controller 204, and transferring user data 103 through the system interface unit 202 or the near-field wireless transceiver 208 in a block 402; identifying a multi-hop map 116 by the device controller 204 for the near-field wireless transceiver 208 in a block 404; and handing-off the host command 107 through the wireless link 110 in a block 406.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. An electronic system comprising:
a storage device configured to receive a host command including:
a system interface unit,
a device controller, coupled to the system interface unit, configured to analyze the host command,
a near-field wireless transceiver, coupled to the device controller, configured to communicate through a wireless link, and
a non-volatile storage array, coupled to the device controller, configured to store user data for transfer through the system interface unit or the near-field wireless transceiver;
wherein:
the device controller can configure the near-field wireless transceiver for identifying a multi-hop map; and
the near-field wireless transceiver is configured to hand-off the host command through the wireless link.

2. The system as claimed in claim 1 wherein the device controller is further configured to communicate with a network aware device driver to hand-off the host command.

3. The system as claimed in claim 1 wherein the device controller can access the multi-hop map and a storage network command for transferring the user data through the wireless link to another of the storage device.

4. The system as claimed in claim 1 wherein the device controller is configured to:
receive the host command for a small transfer of the user data; and
generate a storage network command to transfer the user data through the near-field wireless transceiver.

5. The system as claimed in claim 1 wherein the near-field wireless transceiver configured to communicate through the wireless link includes accessing a storage network through the wireless link for completing a small transfer of the user data to another solid-state storage device.

6. The system as claimed in claim 1 wherein the device controller is configured to:
receive the user data through the near-field wireless transceiver;
store the user data in the non-volatile memory array; and
respond to the host command through the system interface unit.

7. The system as claimed in claim 1 wherein the device controller can configure the near-field wireless transceiver to monitor the wireless link and can update the multi-hop map and monitoring a status of another solid-state storage device in a storage network.

8. The system as claimed in claim 1 wherein the near-field wireless transceiver configured to communicate through the wireless link includes the device controller constructing the multi-hop map for a storage network.

9. The system as claimed in claim 1 wherein the device controller is configured to:
receive the host command through the system interface unit;
retrieve the user data from the non-volatile memory array; and
transfer the user data through the near-field wireless transceiver.

10. The system as claimed in claim 1 wherein the system interface unit is configured to communicate with a network aware device driver, including receiving the host command for handing-off the host command through the near-field wireless transceiver.

11. A method of operation of an electronic system comprising:
receiving a host command by a storage device including:
transferring the host command by a system interface unit,
analyzing the host command by a device controller,
communicating through a wireless link via a near-field wireless transceiver configured by the device controller, and
transferring user data through the system interface unit or the near-field wireless transceiver;
identifying a multi-hop map by the device controller for the near-field wireless transceiver; and
handing-off the host command through the wireless link.

12. The method as claimed in claim 11 wherein handing-off the host command through the wireless link includes communicating with a network aware device driver to hand-off the host command.

13. The method as claimed in claim 11 further comprising accessing the multi-hop map and a storage network command for transferring the user data through the wireless link to another of the storage device.

14. The method as claimed in claim 11 further comprising:
receiving the host command for a small transfer of the user data; and
generating a storage network command for transferring the user data through the near-field wireless transceiver.

15. The method as claimed in claim 11 further comprising accessing a storage network through the wireless link for completing a small transfer of the user data to another solid-state storage device.

16. The method as claimed in claim 11 further comprising:
receiving the user data through the near-field wireless transceiver;
storing the user data in the non-volatile memory array; and
responding to the host command through the system interface unit.

17. The method as claimed in claim 11 further comprising monitoring a status of one or more of the solid-state storage device in a storage network and updating the multi-hop map per the status.

18. The method as claimed in claim 11 further comprising constructing the multi-hop map for a storage network by the near-field wireless transceiver communicating through the wireless link.

19. The method as claimed in claim 11 further comprising:
receiving the host command through the system interface unit;
retrieving the user data from the non-volatile memory array; and
transfer the user data through the near-field wireless transceiver.

20. The method as claimed in claim 11 further comprising communicating with a network aware device driver, in a host controller, including receiving the host command for handing-off the host command through the near-field wireless transceiver.
